(19) United States
(12) Patent Application Publication
(10) Pub. No.: US 2020/0409985 A1
(43) Pub. Date: Dec. 31, 2020

(54) ADDING CUSTOM AND DYNAMIC MULTIMEDIA TO TARGET FILES

(71) Applicant: DokyToky Inc., Las Vegas, NV (US)

(72) Inventors: William Robert Nelson, Las Vegas, NV (US); Joshua Michael Huntington, Angeles City (PH); Scott Christopher Winters, Austin, TX (US)

(21) Appl. No.: 16/887,565

(22) Filed: May 29, 2020

Related U.S. Application Data
(60) Provisional application No. 62/866,101, filed on Jun. 25, 2019.

(51) Int. Cl. G06F 16/438; G06N 20/00; G10L 13/04; G06F 40/14

(52) U.S. Cl. CPC G06F 16/4393; G06F 40/14; G10L 13/043; G06N 20/00

(57) ABSTRACT

Methods and apparatus, including computer program products, implementing and using techniques for converting a target file into a multimedia presentation. A target file including text is received. A class of the target file is identified based on characteristics of the target file. A multimedia presentation is created that contains speech rendered from a portion of the text, additional text, wherein the portion of the text is selected in accordance with a template programmed with content and logic for the identified class, a visual representation of the document, and one or more manipulations of the visual representation defined in accordance with the content and logic of the template. In response to a user command to run the multimedia presentation, the speech, visual representation, and/or the manipulations are output in accordance with the logic of the template.

### BACKGROUND

The present invention relates to digital documents, and more specifically, to adding multimedia content to digital documents.

Digital documents are becoming increasingly common in a variety of settings. In many settings, documents that were traditionally delivered on paper are instead being delivered digitally to users. While this is undoubtedly more convenient, there are also a number of drawbacks to delivering content in the form of static digital documents. For example, many users tend to scroll through the digital documents quickly on their computer or other electronic devices and fail to pay attention to the detail of the documents, which could result in the user failing to notice important information in the documents.

There is currently only a limited set of ways to make content of digital documents more accessible to users. Typically, this includes enhancing the text itself, for example, by changing font colors, italicizing the text, bolding the text, or highlighting the text. However, this is often not sufficient to grab the user's attention, and therefore it would be beneficial if there were other, better, ways to aid the user in accessing, understanding and gaining increased interest in the content of a digital document, or at least in the most important sections of a digital document.

### SUMMARY

According to one embodiment of the present invention, methods, systems and computer program products are provided for converting a target file to a multimedia presentation. A target file that includes text is received. A class of the target file is identified in accordance with one or more characteristics of the target file. A multimedia presentation is created that includes one or more of: speech rendered from a portion of the text and additional added text, wherein the portion of the text is selected in accordance with a template programmed with content and logic for the identified class, a visual representation of the target file, and one or more manipulations of the visual representation of the target file defined in accordance with the content and logic of the programmed template. In response to a user command to run the multimedia presentation, one or more of the speech, the visual representation of the target file, and the one or more manipulations are output, for example, through a web browser, in accordance with the logic of the template.

The details of one or more embodiments of the invention are set forth in the accompanying drawings and the description below. Other features and advantages of the invention will be apparent from the description and drawings, and from the claims.

### BRIEF DESCRIPTION OF THE DRAWINGS

FIG. 1 shows an exemplary user interface for how to create a template, in accordance with one embodiment.

FIG. 2 shows examples of pseudo programming code implementing post processes in a template, in accordance with one embodiment.

FIG. 3 shows a flowchart for a use scenario, in accordance with one embodiment.

FIG. 4 shows a user interface for creating a field, in accordance with one embodiment.

FIG. 5 shows a user interface for applying a field to a certain location in a target file, in accordance with one embodiment.

FIG. 6 shows a user interface for naming a variable, in accordance with one embodiment.

FIG. 7 shows an example of a card configured to play a media file, in accordance with one embodiment.

FIG. 8 shows an example of a user interface for creating a node, in accordance with one embodiment.

FIGS. 9-10 show an example of a user interface for creating a card having a user interaction feature, in accordance with one embodiment.

Like reference symbols in the various drawings indicate like elements.

### DETAILED DESCRIPTION

### Overview

The various embodiments of the invention pertain to techniques for enhancing electronic digital still media, such as digital documents, web sites, or photos, just to mention a few examples. In one implementation, an online application allows users to add sound, images, highlights, videos, and text overlays to still, computerized media so that the still media becomes “alive” and can tell their own story. It should be noted that while the invention will be described herein by way of example of an online application, there can also be standalone implementations that can be run on local computing devices, or various combinations of online and local applications, that perform the same functionality, so the embodiments described herein should not be construed as limiting the scope of the invention.

Various implementations use a combination of text-to-speech technology and information specific to each still media to automatically create customized templates. As will be described in further detail below, the customization includes not only variable data but also alternative paths, based on the logical relationships between the contents of the media and outside data sources and/or user interaction. A unique graphical user interface facilitates easy implementation of logically driven templates. Once a template has been created, similar media can be automatically processed, thereby bringing to life many customized still media having the same general format but different contents. Audio files that are created for each presentation can also be sent to users via email, link, phone call, or be left on their voicemail on demand according to a predetermined schedule.

### Terminology

The following concepts will be used throughout the remainder of this document and are provided here to aid the reader with the understanding of the following description and claims.

Target Files are the original static files that are to be enhanced into multimedia presentations, in accordance with various embodiments of the invention.

Multimedia Presentations are target files or replicas of target files, such as PDF documents, images, or web pages, after being augmented with sound, video, highlights, viewer interactions, etc., as will be described below.

Templates are files used to process similar target files into multimedia presentations. A typical template contains a tree or flowchart of Cards and Nodes (defined below) that specify the multimedia that is added to the target files processed through that template, along with designated areas to extract variables, and any other global settings applicable to all similar target files.

Variables are data that can be identified and extracted from a target file for use in presentations.

Fields are areas of target files that are identified as places where a variable, is expected to be located. If the variable is always in precisely the same location on the page of the target file, then a small field can be used and the entire contents of the field can be used as a variable. Alternatively, if the location of the variable on the page changes, then Post Processing will likely be required.

Post Processing is used to extract the precise data within a field, as if a large “net” were cast but only a precise subset of the contents is to be used as a variable. The mechanism for adding and customizing Post Processing will be described in further detail below.

Cards are collections of content and information that can be added to target files to convert the target files into a multimedia presentation. Cards can hold information about, for example, text to be converted by text-to-speech technology (where the text may contain variables extracted from the target file or from outside data sources). Cards can include information about highlighting portions of a target file, including the location, shape, color, and timing of such highlights. Cards can include information about accessing and playing, audio files, video files, etc., just to mention a few examples.

Nodes are essentially calculators that provide an answer to a calculation. A common use of nodes is to determine the path of a presentation contingent on logical statements or viewer interactions. For example, a node can be set up in such a way that if a viewer's account balance is higher than last month, then the flow can proceed to the card that plays video A, and if the viewer's account balance is lower or equal to last month then the flow can proceed to a different card that plays video B. The viewer can also be asked whether they want the Short Presentation of Long Presentation of a document. A Node calculation can also output a number or text to be used in Card.

Calculators are nodes that perform calculations and output a value, without directly determining a direction of the presentation, that is, which card or node is played next.

Output Files are multi-media files which contain the code that turns a target file into a presentation. In the case of a processed PDF or image, the Output File typically plays an image of the original document with enhancements within a web browser. If the target file is already intended for viewing in a web browser, then the output file will typically not create an image of the target file but will rather add the multimedia enhancements to the original target file's code.

DocID is used to sort target files according to similarity. DocID templates essentially measure what percentage of the content of a target files is able to be successfully processed by the DocID template. A higher DocID score for a target file indicates a higher likelihood that the target file should be processed by that template. If two target files both have high DocID scores, then they are considered similar.

### User Experience

In one embodiment, four categories of users interact with the application during various stages: Viewers, Processors, Template Technicians, and Client Web Site Developers. The user experiences for each of these categories of users will be described in this order, which is from simplest to most complex.

The first user category, the viewers, are the end users of the application. Imagine a scenario in which a PDF (Portable Document Format) document has been processed using the application described herein. Once the viewer opens the PDF document, she will see a play button. Upon clicking the play button a browser will open and a video will start. The video is a duplicate of the original image (i.e., the PDF document) with sound and visual effects added to the duplicate image.

For example, when the video for a financial statement is played, it might tell the viewer that her account balance is $1,000, while scrolling to and highlighting the $1,000 value on the image. Similarly, for a webpage, the viewer will see a play button, and upon clicking the play button, sound and visual overlays, other multimedia and/or navigation appears on the web page. However, in this case there is no need to convert the web page to an image. As the skilled person realizes, while this example is very basic, templates added to media can be very complex, as will be described in further detail below.

The second user category, the processors, can be described as the “standard operators” of the application. The processors upload a batch of target files to the application, and templates are applied to the target files, thereby adding multimedia to the target files to create multimedia presentations. The multimedia can include video, graphics (e.g., highlights), speech timed with the graphics, etc. For example, when a post processed PDF document is viewed, one way to provide the experience is by launching a video. However, if a web page is viewed, the multimedia can be provided as an overlay to the web page rather than in a video. When to have different processes for each is primarily determined by the technical constraints of the target files, templates, and the viewing environment of the resulting multimedia presentation. Typically, processors are only required if target files are being preprocessed in a batch. The system can process target files in real time, such as when a play button or a PDF of web page is clicked. Advantages of preprocessing include elimination of the need for Internet connectivity to play the presentation and potentially reduced delay between clicking play and starting the presentation.

The output of the process is a set of multimedia presentations corresponding to the set of target files. In some embodiments the multimedia presentations call a video file, which can be hosted on the Internet or be embedded in the multimedia file itself. In some embodiments, the multimedia presentation is output in the form of an HTML file, which to a viewer functions like an interactive video, as was described above. In the case of a processed PDF document, the “Play” button in the PDF document calls the HTML file (which may be embedded into the PDF document itself or located on a remote server) and the HTML file opens in the viewers browser. The HTML file can play full motion video including sound and interaction. As was described above, the viewer can also interact with the presentation to choose different paths through the presentation or answer survey type questions that are identified as being entered from their specific HTML file and saved to a database. In the case of a web page, the presentation HTML can be delivered to the viewer's browser to augment the existing web page. In some embodiments, if the web page owner decides to process their own web page into a presentation, then the augmentation HTML can be provided by the site owner to the viewer. In the different scenario where the web page visitor wanted to process the webpage without the page owner's permission, then a program not associate with the site owner, such as a browser extension, can be used to process the page and provide the augmentation HTML to the visitor's browser.

The third user category, the template technicians, create the templates that are used by the processors. Templates are typically created by adding a set of rules, audio, video, text, highlight, images and other multimedia effects to a target file. In some implementations, a template editor is used by the template technicians to create templates. In one embodiment of the template editor constructs a tree of cards and nodes to define the logical flow and content of a template.

The fourth category of users, the client website developers, add code to their website for calling the online application, implementing the appropriate template and sending the processed data, such as video files, etc., as part of their site visitors' page loads. It should be noted, while these four user types have been described separately, a single individual may belong to several user categories. For example, a user may be both a template technician and a processor, and so on.

### Implementation Details for Various Embodiments of the Invention

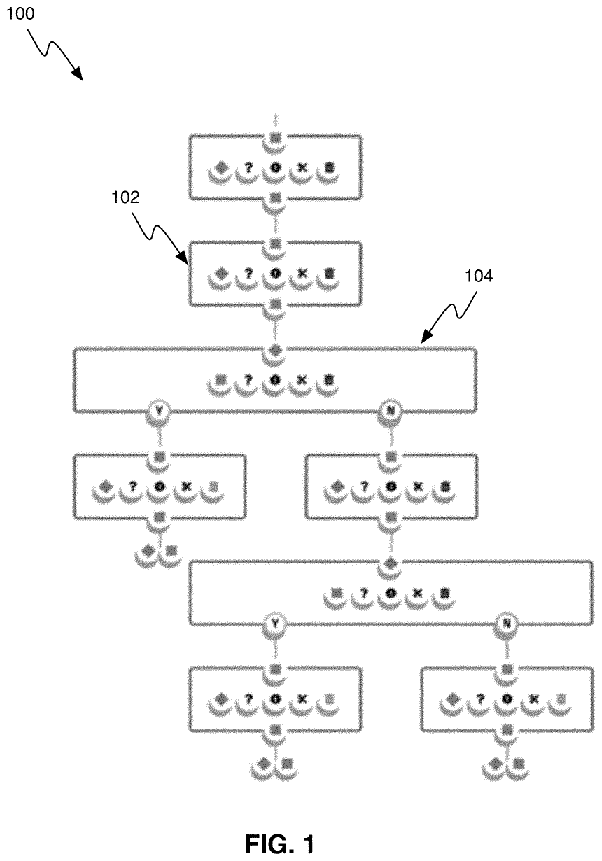

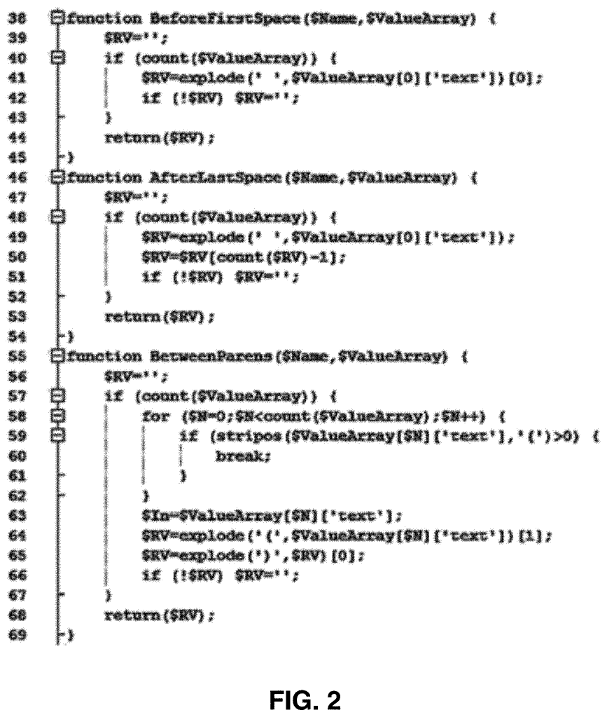

FIG. 1 shows an exemplary user interface 100 for creating a template, in accordance with one embodiment. The narrow boxes shown in FIG. 1 represent cards 102 and the wide boxes represent nodes 104. As was described above, a card 102 is a collection of content and information that can be added to a target file. Typically, a card 102 includes an audio file, a video file, a location, a field, and/or visual effects (such as highlights, text, images, etc.). Calculators are used in the cards 102 and nodes 104 to take data from media file and/or other private or public data sources and combine the data into an output value that can be used by cards 102 and nodes 104. For example, a brokerage statement may contain the start and end of the month values of the account but does not contain the account's percentage gain or loss. The starting value minus ending value divided by the starting can be calculated and the value can be used in a card containing the script “The return of your account this month equals XX %.” The example is very simple but essentially any formula can be programmed using information from the document, system databases, or any other data sources such as the Internet.

Fields can serve many purposes. For example, in an “easy use case,” a region of a page can be designated and the text in that region can be captured as a “field.” However, this feature is extensible to further ways of finding text. There are two primary ways to find text: by specific position on the page, or by casting a large “net” and filtering the text inside using Post Processing. Post Processing can be added and customized in various embodiments.

An example of a post process is “BeforeFirstSpace,” which takes all of the text from the region and discards everything except the text before the first space. This is useful, for example, if something like “FirstName” is needed, but the statement puts first middle and last name all on the same line. Since only the general area where the whole name appears is known and it is not possible to anticipate the exact location of the entire first name, the region can be defined to cover where the whole name appears and then just extract the part of the text which appears before the first space. Conversely, an “AfterLastSpace” Post Process can be used to filter the text and discard everything prior to the last space, which may be useful for extracting only the last name. For example, the last name for “Rex. P. Jones” will appear in a different place than the last name of “Reginald Quincy Adams” even if the two “R”s fall at exactly the same location.

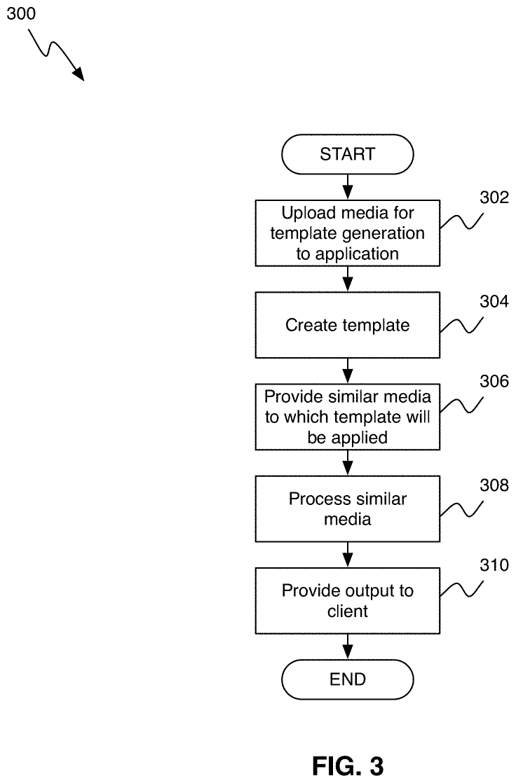

Another example is a “BetweenParens” Post Process. This Post Process takes an area of text and returns only the portion within parenthesis. For example, if the BetweenParens Post Process is applied to the phrase: “In this example (only this text) will be returned,” the resulting output will be “only this text”. FIG. 3 shows exemplary implementations of the Post Processes BeforeFirstSpace, AfterLastSpace and BetweenParens, respectively.

As can be seen in FIG. 1, cards 102 have a single entry and a single exit, represented by the two circles at the top and bottom, respectively, of the card 102. Nodes 104, on the other hand, represent logic statements and have a single entry and two exits: “Y” for yes on the left and “N” for no on the right (essentially representing true of false for a logical relationship), again represented by the two circles at the bottom of the node 104. A series of cards 102 can form simple template without any logic. More complex logic and granular classification can be created by implementing a series of nodes 104 and cards 102, as shown in FIG. 1. One common step in creating a template is to provide text including variables. As described above, the variables are data extracted from the target file and/or other data sources that will be merged into text, which can be fed to a text-to-voice synthesizer to create an audio file for a card 102.

To clarify how one embodiment of the invention functions, a use case scenario which describes the creation of a Template, processing of a document, and viewing of the document will now be described by way of example and with reference to FIGS. 3-10.

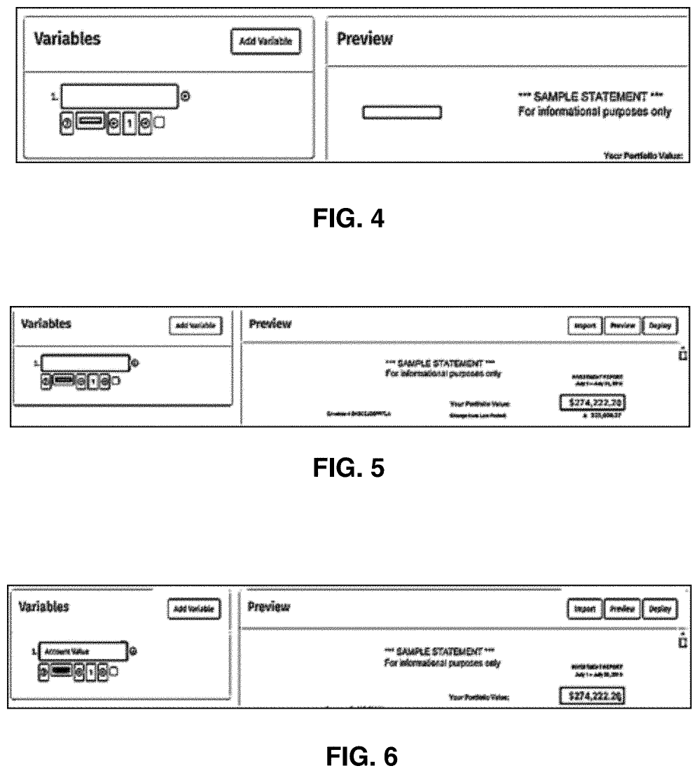

As described above, variables are information identified within the document that a template is being built upon. Variables are created by clicking an “Add Variable” button on a user interface, as shown in FIG. 4. This causes a colored field to appears on the document and which can be placed where the data of interest is located on the document, as shown in FIGS. 4 and 5. The variable can then be given a name, in this case “Account Value,” as shown in FIG. 6. It should be noted that the naming can also precede moving the colored field.

What precise information from within the field is used can be specified using a wide variety of Post Process rules, such as “After the colon”, “Find Nth field”, or “SumVars” which can sum the highest three numbers in a location field according to the rule “1stMax %,2ndMax %,3rdMax %”. Fields are used to identify the location of the variables.

Media files to be used in a template can include various combinations of audio, video, or text-to-speech audio. Audio and video files are typically uploaded, whereas text-to-speech audio typically is created by merging commonly fixed text with Variable information, and using an external text-to-speech processor to create a text-to-speech file. Once the variables and media files have been defined, they can be used cards and nodes that together form the tree of cards and nodes that define a template.

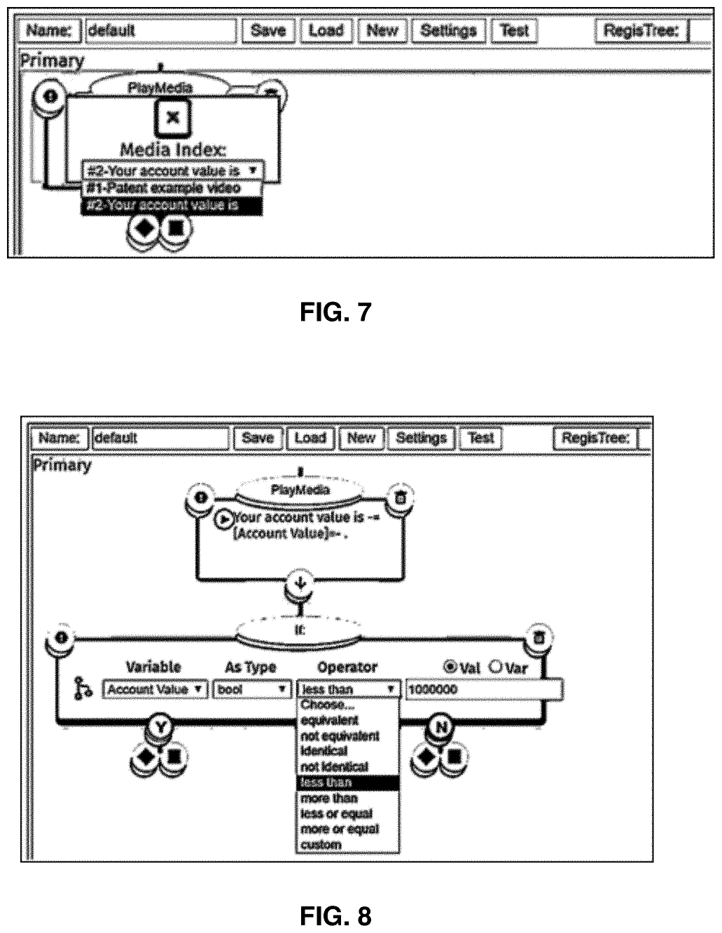

FIG. 7 shows an example of a card configured to play a media file called “Your account value is”. This constitutes the beginning of the multimedia presentation that will be seen by the viewer. That is, when the viewer clicks “play media” she will hear and see “Your account value is XXX,” where XXX is a number extracted from her account statement.

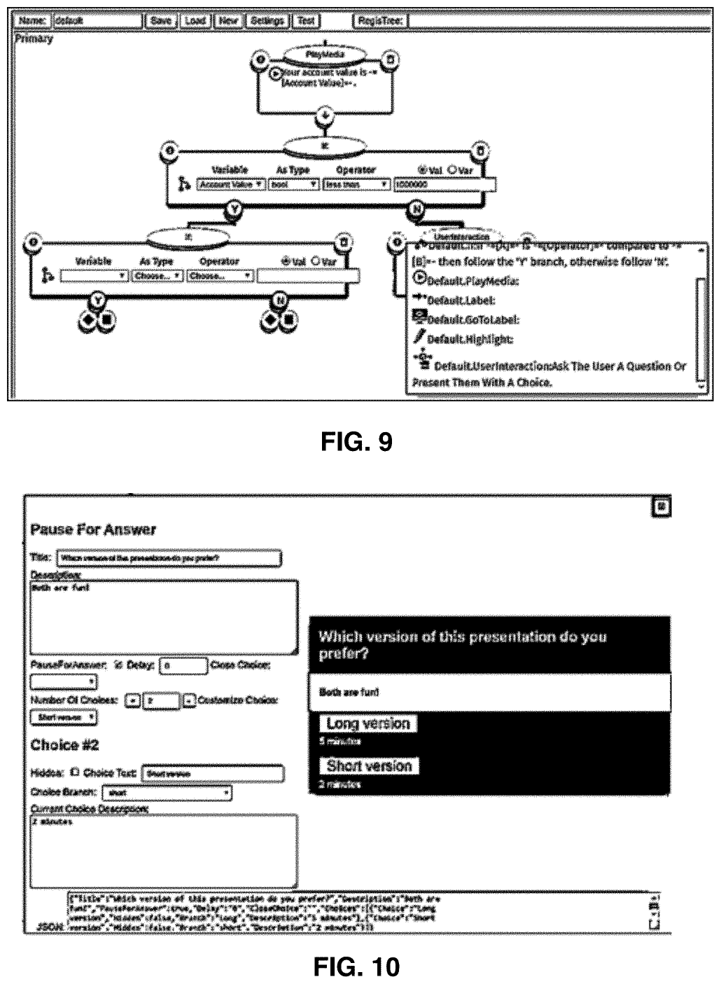

Next, a node is created, which takes the viewer down one path if the account value is less than $1,000,000 and another path if the account value is more than or equal to $1,000,000. The “Y” standing for “yes” on the left box bottom, and “N” standing for “no” on the right box bottom, respectively indicate which path will be taken from the node, based on the evaluation of the condition described in the node. Each of the right and left paths can cascade into an essentially unlimited number of additional cards and nodes, including “User Interactions” which facilitates asking the viewer a question and collecting a response that is saved in a database and, which can determine the next card or node to which the user is taken. FIG. 8 shows an example of a user interface for creating such a node, in accordance with one embodiment. Examples of user interfaces for creating such a “User interaction” feature of a card are shown in FIGS. 9-10.

As can be seen in FIG. 3, the process starts by a processor uploading media, such as a generic brokerage statement, that is to be turned into a template to the application, step 302. The uploading can be made over a network using conventional techniques that are familiar to those having ordinary skill in the art.

Next a template is created as described above, step 304. It should be noted that in some embodiments, the creation of a template can also be partly or fully automated based on rules and the content of the media. In some embodiments, neural networks, machine learning, and artificial intelligence can also learn over time specific user behaviors when creating templates so that the process can be further automated over time.

After the template has been created, similar media is provided to which the template should be applied, step 306. For example, a processor may upload a folder of brokerage statements to the system. Such similar media can be identified, for example, using the DocID. Fields in the document can be used by the DocID system to determine whether a document meets the criteria for applying a particular template. In one embodiment, the DocID can be implemented as a series of nodes, to identify and classify media and to determine which template should be applied to the media.

The similar media is then processed using the template, step 308. As was mentioned above, the template adds multimedia to similar documents based on a set of rules and logical relationships, for example, a sequence of audio files to be played (or not) based on the logical relationships among content in the document. The processing typically also includes determining the timing for displaying each visual effect during the playing of each audio or video file to display each effect, such as an image, text, highlight, or video. To continue the example with the broker statements, the template would know the coordinates where the account owner's name is located on the brokerage statement and where the date is located on the brokerage statement. The account owner's name and dates are merged into a script such as “This is the brokerage account of John Doe as of June 30, 2020.” The script is sent to the text-to-speech processor and an audio file is returned. The template may also contain instructions to highlight both the name and the date in yellow during the entire duration of the script being read or any other timing desired. As the skilled person realizes, what is highlighted and when is completely flexible.

The output from the processing is then provided to the client, step 310, which ends the process. The output can vary depending on the particular situation at hand. For example, PDF documents can be batch processed and the resulting multimedia presentations can be provided in a folder. Web pages, on the other hand, may be processed on demand and provided to the site visitor when their web page loads, as was described above. In the brokerage statement example, the output file can be a video containing images of the Statement with highlights over the specified locations at the specified times while the audio from the script is being played.

In some embodiments, a user interface can be provided that allows a template technician or processor user to quickly verify whether a template is working as expected on multiple documents that are being processed. For example, the user interface can be a matrix in which each row represents a document that was processed and each column represents a card or a node. The outcome of each card or node can be color coded, allowing the user to easily observe patterns of performance of the template.

### General Implementation Details

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed.

For example, in some implementations, there may not be a clear distinction between cards and nodes, and cards can include some logic. However, for ease of implementation and use, it is preferred that the delineation described above between cards and nodes be used. In some implementations, there may not be any nodes, though this would only make it possible to have logic free templates possible (unless logic was implemented in the cards instead). In yet other embodiments, text to speech may be eliminated, though this also eliminates any variable voice content on automatically created presentations. Lastly, it should be noted that while the above examples have been described in the context of financial documents, the principles of the various embodiments of the invention can be applied to a wide range of documents, such as flow charts, architectural blueprints, web pages, and various types of documents or images, just to mention a few alternatives.

Thus, as can be seen, many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for converting a target file into a multimedia presentation, comprising:
receiving a target file that includes text;
identifying a class of the target file in accordance with one or more characteristics of the target file; and
creating a multimedia presentation including one or more of:
speech rendered from a portion of the text and additional text, wherein the portion of the text is selected in accordance with a template programmed with content and logic for the identified class,
a visual representation of the target file, and
one or more manipulations of the visual representation of the target file defined in accordance with the content and logic of the template.

2. The method of claim 1, further comprising:
in response to a user command to run the multimedia presentation, outputting one or more of: the speech, the visual representation of the target file, and the one or more manipulations in accordance with the logic of the template.

3. The method of claim 1, wherein the template is represented as a tree of cards and nodes forming logical relationships, wherein:
one or more cards which contain content to be displayed in the visual representation of the target file, and
one or more nodes which determine a flow of the multimedia presentation through the logical tree.

4. The method of claim 1, wherein the template contains instructions for extracting text from the target file based on the location of the text within the target file.

5. The method of claim 4, further comprising processing the extracted text in accordance with a set of post processing rules.

6. The method of claim 1, wherein the template is automatically created at least in part, based on rules and content of a target document.

7. The method of claim 1, wherein the template is automatically created using machine learning and artificial intelligence, based at least in part on data collected during client interaction with the multimedia presentation.

8. The method of claim 1, wherein the one or more manipulations of the visual representation include a timing for how different portions of the visual representation will be displayed to a user.

9. A computer program product for converting a target file into a multimedia presentation, the computer program product comprising a computer readable storage medium having program instructions embodied therewith, wherein the computer readable storage medium is not a transitory signal per se, the program instructions being executable by a processor to perform a method comprising:
receiving a target file that includes text;
identifying a class of the target file in accordance with one or more characteristics of the target file; and
creating a multimedia presentation including one or more of:
speech rendered from a portion of the text and additional text, wherein the portion of the text is selected in accordance with a template programmed with content and logic for the identified class,
a visual representation of the target file, and
one or more manipulations of the visual representation of the target file defined in accordance with the content and logic of the template.

10. The computer program product of claim 9, further comprising instructions to perform the step:
in response to a user command to run the multimedia presentation, outputting one or more of: the speech, the visual representation of the target file, and the one or more manipulations in accordance with the logic of the template.

11. The computer program product of claim 9, wherein the template is represented as a tree of cards and nodes forming logical relationships, wherein:
one or more cards which contain content to be displayed in the visual representation of the target file, and
one or more nodes which determine a flow of the multimedia presentation through the logical tree.

12. The computer program product of claim 9, wherein the template contains instructions for extracting text from the target file based on the location of the text within the target file.

13. The computer program product of claim 10, further comprising instructions to process the extracted text in accordance with a set of post processing rules.

14. The computer program product of claim 9, wherein the template is automatically created at least in part, based on rules and content of the target document.

15. The computer program product of claim 9, wherein the one or more manipulations of the visual representation include a timing for how different portions of the visual representation will be displayed to a user.

16. The computer program product of claim 9, wherein the template is automatically created using machine learning and artificial intelligence, based at least in part on data collected during client interaction with the multimedia presentation.

17. A system converting a target file into a multimedia presentation, comprising:
a processor; and
a memory containing instructions that when executed by the processor causes the following steps to be performed:
receiving a target file that includes text;
identifying a class of the target file in accordance with one or more characteristics of the target file; and
creating a multimedia presentation including one or more of:
speech rendered from a portion of the text and additional text,
wherein the portion of the text is selected in accordance with a template programmed with content and logic for the identified class,
a visual representation of the target file, and
one or more manipulations of the visual representation of the target file defined in accordance with the content and logic of the template.
